(19) United States
(12) Patent Application Publication
(10) Pub. No.: US 2016/0196498 A1
(43) Pub. Date: Jul. 7, 2016

(54) SYSTEM FOR GENERATING FABRICATED PATTERN DATA RECORDS

(71) Applicant: DEUTSCHE TELEKOM AG, Bonn (DE)

(72) Inventors: Barak CHIZI, Ashkelon (IL); Bracha SHAPIRA, Beer Sheva (IL); Lior ROKACH, Omer (IL); Dudu MIMRAN, Tel Aviv (IL); Ariel BAR, Ashdod (IL); Stefan ZEIDLER, Berlin (DE); Andreas REDERER, Berlin (DE)

(21) Appl. No.: 14/979,640

(22) Filed: Dec. 28, 2015

(30) Foreign Application Priority Data
Jan. 1, 2015 (IL) 236557

(51) Int. Cl. G06N 5/04; G06N 7/00; G06N 99/00

(52) U.S. Cl. CPC G06N 5/047; G06N 99/005; G06N 7/005

(57) ABSTRACT

A system for generating fabricated pattern data records (XDRs) based on data from accessible data sources, which comprises an XDR core module containing one or more modeling and pattern creation modules for modeling original data received from the data sources; one or more synthetic data generation modules for generating fabricated data, based on the patterns created by the modeling and pattern creation modules; a data splitting module for splitting the data into training and testing sets according to a predetermined policy; an XDR storage database for storing created patterns and fabricated data; a configuration manager for controlling the operation of the modeling and pattern creation modules and of the synthetic data generation modules; a plurality of XDR agents being software components for communicating with the data sources and accessing relevant data, using a unique API of each data source. Each of the XDR agents is capable of identifying the data-structures of its corresponding data source; transforming the data structures into a unified input structure being used by the XDR core module; a data-store communication module for mediating between the XDR agents and the XDR core modules by using data transformation.

### FIELD OF THE INVENTION

The invention is in the field of communication platforms. More specifically, the invention relates to a system for generating fabricated pattern data records.

### BACKGROUND OF THE INVENTION

In the modern world, the use of communication networks is almost inevitable, weather if it is cellular communication or computers communication or any other communication platforms. The communication companies have therefore, records about every user. From these records a lot of information can be derived; however, using real data of any communication network has always caused a serious privacy problem. General speaking, the main problem is connected by the need for protecting the users from unsupervised monitoring. Nevertheless, the need of knowing the nature of data can yield significant value for many applications (marketing, sales, and customer service).

Other systems are also capable of collecting various types of user data or all sorts of data. These systems may include social web sites, search engines and wearable computing. This huge amount of collected data may be used for all sorts of analysis. Commercial data may also be beneficial for such analysis. However, privacy and security must be kept while using this data.

It is therefore an object of the present invention to provide a system for generating fabricated pattern data records, based on modeling of actual networks of various types.

It is another object of the present invention to provide a system for generating fabricated pattern data records, which keeps the users' privacy and the security of the collected data.

Further purposes and advantages of this invention will appear as the description proceeds.

### SUMMARY OF THE INVENTION

The present invention is directed to a system for generating fabricated pattern data records (XDRs) based on data from accessible data sources, which may comprise:
a) an XDR core module containing:
   one or more modeling and pattern creation modules for modeling original data received from the data sources;
   one or more synthetic data generation modules for generating fabricated data, based on the patterns created by the modeling and pattern creation modules;
   a data splitting module for splitting the data into training and testing sets according to a predetermined policy;
   an XDR storage database for storing created patterns and fabricated data; a configuration manager for controlling the operation of the modeling and pattern creation modules and of the synthetic data generation modules;
b) a plurality of XDR agents being software components for communicating with the data sources and accessing relevant data, using a unique API of each data source, each of the XDR agents is capable of:
   identifying the data-structures of its corresponding data source;
   transforming the data structures into a unified input structure being used by the XDR core module;
c) a data-store communication module for mediating between the XDR agents and the XDR core modules by using data transformation.

The modeling and pattern creation modules may use Model and Patterns Creation algorithms (MPCs), which can discover patterns that reflect the relationships, conditions and constants of the available data.

The modeling tasks may include:
state-transitions learning of a system or an individual;
learning probabilistic cause-effect conditions among a given set of random variables;
context-aware learning.

The synthetic data generation modules may use Syntactic Data Production (SDP) algorithms to generate new and fabricated data samples utilizing the models learned by the MPCs.

The system may further comprise a Query API and a Query Processer to receive and process data-generation queries, as well as a query cache for caching queries and query results and a User Interface for allowing interaction with the XDR core module and server-side components. The data sources may be located locally on the computerized device that runs the data fabrication system, or on an external computerized device.

The data splitting module may split the data into training and testing sets by using random based or time based splitting. Data may be aggregated and prepared for further usage.

All the above and other characteristics and advantages of the invention will be further understood through the following illustrative and non-limitative description of embodiments thereof, with reference to the appended drawings. In the drawings the same numerals are sometimes used to indicate the same elements in different drawings.

### BRIEF DESCRIPTION OF THE DRAWINGS

FIG. 1 schematically illustrates the logical components of the proposed system.

### DETAILED DESCRIPTION OF EMBODIMENTS OF THE INVENTION

The present invention relates to a system which is capable of fabricating synthetic data (hereinafter called X Data Records or XDRs) from any available data source, while providing a high degree of similarity between the original data and the synthetic data. An XDR may be any type of data record, such as Call Data Record (CDR), data regarding operations performed by a user, purchasing records of users at points of sale, traveling records etc.

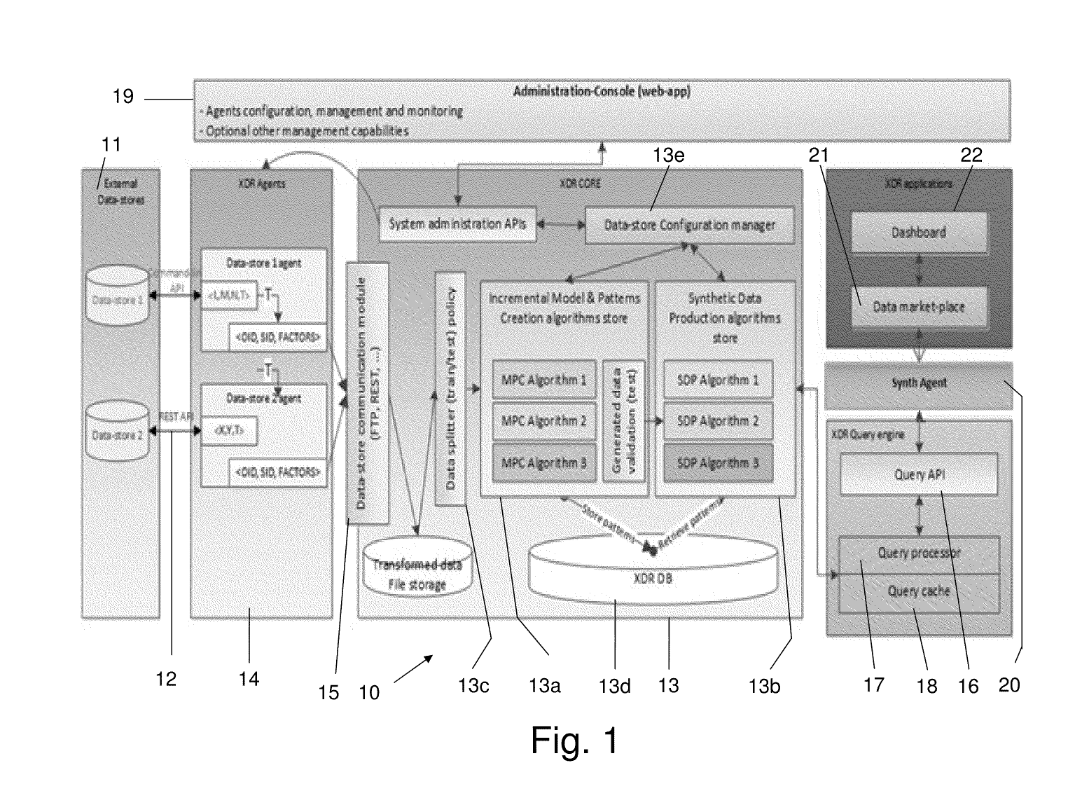

FIG. 1 schematically illustrates the main logical components of a system for generating fabricated pattern data records of telecommunication platforms, as proposed by the present invention. The system 10 is capable of connecting to any available (external) data source 11 via the available API 12 of that data source. The external data source is the target data source from which it is required to fabricate data. These data sources can be located locally on the computerized device that runs the data fabrication system, or on an external computerized device.

System 10 includes an XDR core module 13, which is the main component and contains the following sub-components:
modeling and pattern creation modules 13a, including algorithms for modeling of the received original data;
synthetic data generation modules 13b, including algorithms for generating fabricated data, based on the patterns created by the modeling and pattern creation modules 13a;
a data splitting module 13c including algorithms for splitting the data into training and testing sets according to a certain predetermined policy (i.e., a random based split, or a time based split);
an XDR storage database 13d for storing created patterns and fabricated data;
a configuration manager 13e for controlling the operation of the modeling and pattern creation modules 13a and of the synthetic data generation modules 13b.

System 10 also includes XDR agents 14, which are software components that communicate with the data sources and access the relevant data. Each XDR agent 14 knows the unique APIs of each data-store, as well as the data-structures. It also knows how to transform these data structures into a unified input structure that is compatible with the algorithms used by the XDR core module 13. A specific XDR agent 14 must be implemented for each target data source 11.

A data-store communication module 15 is responsible for mediating between the XDR agents 14 and the XDR core module 13 by using a flexible method of transforming data from the XDR agents 14 into the XDR storage database 13d.

Splitting the data by the data splitting module 13c is required in order to evaluate the generated models in the next section. Models are trained solely on the training set, while the testing set is utilized to evaluate the generated models using maximum likelihood estimation. The data splitting module 13c is controlled by the splitting criteria (i.e., random-based or time-based) and the splitting ratio (typically a ratio of 90:10).

The Model and Patterns Creation (MPC) are sets of algorithms (used by the modeling and pattern creation modules 13a) which are capable of discovering patterns that reflect the relationships, conditions and constants of the available data. He modeling tasks may be context-aware learning, learning of state-transitions of a system or an individual, or learning probabilistic cause-effect conditions among a given set of random variables. All the learning models have the capability of updating the generated models incrementally, using batch updates.

Examples for data modeling tasks can be:
Modeling the trajectory sequences of individuals (the states of which can be spatial coordinates, cell towers, points of interest, etc.).
Modeling a song playlist (the states can be the genre of the song: pop, dance, rock, etc.).
Modeling the sequence of file system operations (states are sets of commands like “open”, “read”, “write”, “delete”, etc.).

Examples for learning cause effect between ransom variables can be:
Users profile records which may contain: age, gender, education, income, relationship-status, etc.
Call center records which may contain: call length, topic, product category, customer-age, customer-credit-level, and call-sentiment.
Medical/diagnostic records: test1 results, test2 results, blood pressure, is Smoking Indicator and a final diagnostic.
   Data Market place

The purpose of the Data Market Place 21 is to provide a platform for creating, offering and obtaining synthetic data. It is targeted at Business Partners and interested instances in general. Users can request synthetic data samples in different volumes from multiple domains according to specific queries. Synthetic records can be marked as public or private for certain users groups.

### Dashboard

The dashboard 22 is graphic user interface component, which expose the functionality of the Data market both for admin users and clients.

The Syntactic Data Production (SDP) algorithms (used by synthetic data generation modules 13b) are used to generate new and fabricated data samples utilizing the models learned by the MPCs. The syntactic data production algorithm store is required to support several types of algorithms, since each of the pattern creation models may have a unique model representation.

A Query API 16 and a Query Processer 17 receive data-generation queries, processes them, requests the generation from the XDR server (which runs the XDR core module 13), aggregates the data if needed, and finally returns it to the client. The query cache 18 allows queries and query results to be cached in order to accelerate response times.

The queried data can also be re formatted, filtered and processed beyond the query agent via the Synth Agent 20 (in a sense the Synth Agent on the output end is analogous to the XDR Agent on the input end), which is adapted to convert and aggregate tasks that are performed on the fabricated data. For example, it can calculate the estimated number of users on a specific cell-tower at a given time-stamp according the fabricated data of user transitions, which has been modeled by the system.

The XDR administration console 19 is a User Interface (such as a GUI) that enables interaction with the XDR core module 13 and other server-side components.

Although embodiments of the invention have been described by way of illustration, it will be understood that the invention may be carried out with many variations, modifications, and adaptations, without exceeding the scope of the claims

1. A system for generating fabricated pattern data records (XDRs) based on data from accessible data sources, comprising:
a) an XDR core module containing:
one or more modeling and pattern creation modules for modeling original data received from said data sources;
one or more synthetic data generation modules for generating fabricated data, based on the patterns created by said modeling and pattern creation modules;
a data splitting module for splitting the data into training and testing sets according to a predetermined policy;
an XDR storage database for storing created patterns and fabricated data;
a configuration manager for controlling the operation of said modeling and pattern creation modules and of said synthetic data generation modules;
b) a plurality of XDR agents being software components for communicating with said data sources and accessing relevant data, using a unique API of each data source, each of said XDR agents is capable of:
identifying the data-structures of its corresponding data source;
transforming said data structures into a unified input structure being used by said XDR core module;
c) a data-store communication module for mediating between said XDR agents and said XDR core modules by using data transformation.

2. A system according to claim 1, in which the modeling and pattern creation modules use Model and Patterns Creation algorithms (MPCs) being capable of discovering patterns that reflect the relationships, conditions and constants of the available data.

3. A system according to claim 2, in which the modeling tasks include:
state-transitions learning of a system or an individual;
learning probabilistic cause-effect conditions among a given set of random variables;
context-aware learning

4. A system according to claim 2, in which the synthetic data generation modules use Syntactic Data Production (SDP) algorithms to generate new and fabricated data samples utilizing the models learned by the MPCs.

5. A system according to claim 1, further comprising a Query API and a Query Processer to receive and process data-generation queries.

6. A system according to claim 5, further comprising a query cache for caching queries and query results.

7. A system according to claim 1, further comprising a User Interface for allowing interaction with the XDR core module and server-side components.

8. A system according to claim 1, in which the data sources are located locally on the computerized device that runs the data fabrication system, or on an external computerized device.

9. A system according to claim 1, in which the data splitting module splits the data into training and testing sets by using random based or time based splitting.

10. A system according to claim 1, in which the data is aggregated and prepared for further usage.
